(19) United States
(12) Patent Application Publication
(10) Pub. No.: US 2008/0009247 A1
(43) Pub. Date: Jan. 10, 2008

(54) MULTI-FUNCTIONAL MOBILE PHONE

(75) Inventors: Shin-Hong Chung, Shenzhen City (CN); Zai-An Pan, Shenzhen City (CN)

Correspondence Address: NORTH AMERICA INTELLECTUAL PROPERTY CORPORATION, P.O. BOX 506, MERRIFIELD, VA, 22116, US

(73) Assignees: ENSKY TECHNOLOGY (SHENZHEN) CO., LTD., Shenzhen City (CN); ENSKY TECHNOLOGY CO., LTD., Taipei Hsien (TW)

(21) Appl. No.: 11/773,953

(22) Filed: Jul. 5, 2007

(30) Foreign Application Priority Data
Jul. 7, 2006 (CN) 200610061566.0

(51) Int. Cl. H04B 1/44

(52) U.S. Cl. 455/78

(57) ABSTRACT

A mobile communication terminal such as a mobile phone to be used as a wireless microphone is disclosed. The multi-functional mobile phone has a microphone mode option. When the mobile phone is in the microphone mode, a microphone receives external analog signals to a converting unit, which converts the analog signals into digital signals; a processing unit processes the digital signals to the converting unit, the converting unit converts the digital signals into wireless signals, and a second RF module transmits the wireless signals from the converting unit to a multimedia system. The mobile phone to be used as a wireless microphone implements the function of tradition microphones in the multimedia system.

### BACKGROUND OF THE INVENTION

1. Field of the Invention

The present invention relates to a multi-functional mobile phone, and in particular, to a mobile phone that can be used as a wireless microphone.

2. Description of Related Art

Mobile phones are ubiquitous and many mobile phones allow both digital and analog communications as network services offer multimedia functionalities. However, the network bandwidth may be limited and thus the mobile phones, connected to that network, may not utilize its full potential. Thus mobile phones are prime target for being used as substitute for other electronic devices.

One such other electronic device is the microphone. People often make use of a microphone for many purposes, such as conferences (i.e. a symposium), and entertainment programs (i.e. a TV program) because the microphone allows the speaker's voice to be broadcasted across a wide area. Usually, during interactive conferences or speeches, the speaker must hand off his microphone to the next speaker or sometimes a limited number of microphones are arranged among the audience members. Sometimes the audience is so large that the number of the microphones may limit audience participation.

Accordingly, it would be beneficial to allow a mobile phone to be used as a wireless microphone in order to alleviate the above mentioned issues.

### SUMMARY OF THE INVENTION

The primary object of the present invention is to provide a multi-functional mobile phone that can be used as a wireless microphone, wherein the users may make use of the mobile phone to replace a traditional microphone. Simultaneously, if there is an incoming call from another mobile communication terminal, the user may answer the call.

Another object of the present invention is to resolve the inconvenience of passing a traditional microphone among audience members and having to arrange microphones for a program.

Other advantages and novel features will be drawn from the following detailed description with reference to the attached drawing.

### BRIEF DESCRIPTION OF THE DRAWINGS

FIG. 1 is a block diagram of a hardware infrastructure of a mobile phone to be used as a wireless microphone in accordance with a preferred embodiment of the present invention;

FIG. 2 is a schematic view of a graphical user interface (GUI) of the mobile phone of FIG. 1;

FIG. 3 is a flowchart of a preferred method for performing a wireless microphone function in the mobile phone of FIG. 1; and

FIG. 4 is a flowchart of a preferred method for performing an incoming call of the mobile phone of FIG. 1 in the microphone mode.

### DETAILED DESCRIPTION OF THE INVENTION

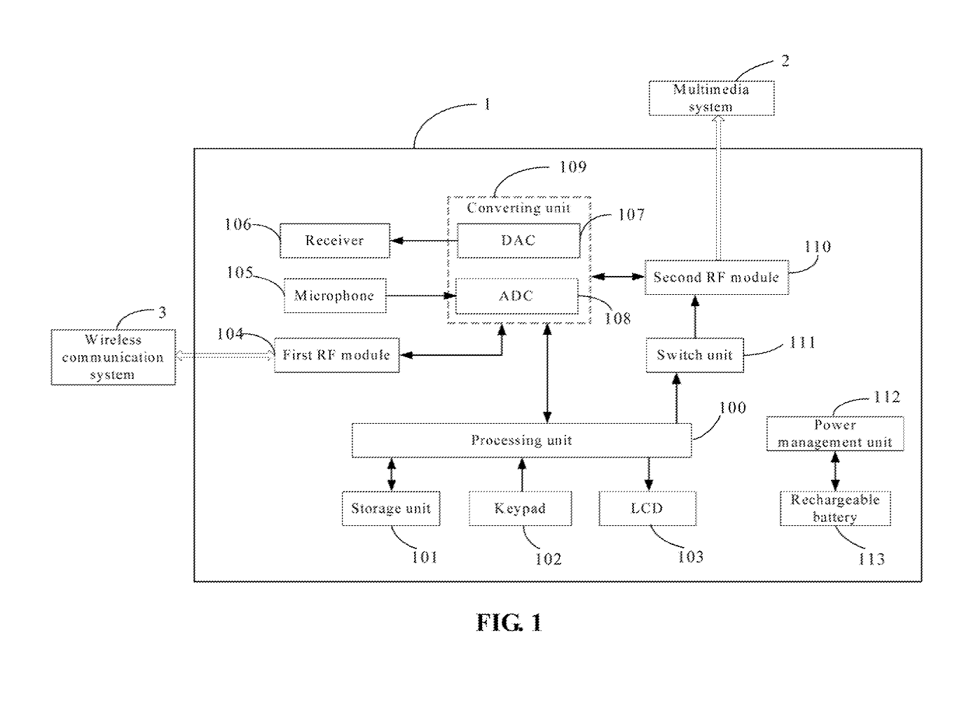

FIG. 1 shows an exemplary mobile phone 1 in accordance with a preferred embodiment of the present invention. In this embodiment, the multi-functional mobile phone (hereinafter the mobile phone) 1 communicates with either a multimedia system 2 or a wireless communication system 3. The multimedia system 2 may be a karaoke system or any other multimedia/sound systems. The wireless communication system 3 may be a global system for mobile communication (GSM), a code division multiple access (CDMA), a general packet radio service (GPRS), or any other wireless network. Furthermore, the multimedia system 2 includes a communication unit (not shown), and the communication unit of the multimedia system 2 communicates with the second radio frequency (RF) module 110. The second RF module 110 may be a Bluetooth module. The mobile phone 1 includes a receiver 106, a microphone 105, a processing unit 100, a storage unit 101, an input unit such as a keypad 102, a display unit such as an liquid crystal display (LCD) 103, a converting unit 109, a switch unit 111, a power management unit 112, a rechargeable battery 13, a first RF module 104, and a second RF module 110.

The receiver 106 receives wireless signals from the wireless communication system 3, and the microphone 105 receives sound. The power management unit 112 is configured for connecting to the rechargeable battery 113 for supplying power to all units of the mobile phone 1. The first RF module 104 is configured for communicating with the wireless communication system 3, that is, the first RF module 104 is configured for sending/receiving signals to/from another mobile communication terminal (not shown) via the wireless communication system 3. The second RF module 110 is connected with the converting unit 109 and the switch unit 111, and is configured for transmitting wireless signals to the multimedia system 2. The converting unit 109 is configured for converting received signals. The converting unit 109 includes a digital to analog converter (DAC) 107 for converting digital signals into analog digitals and the converting unit 109 also includes an analog to digital converter (ADC) 108 for converting analog signals into digital signals. The processing unit 100 is configured for processing digital signals from the converting unit 109 and controlling the mobile phone 1 according to operations on the keypad 102.

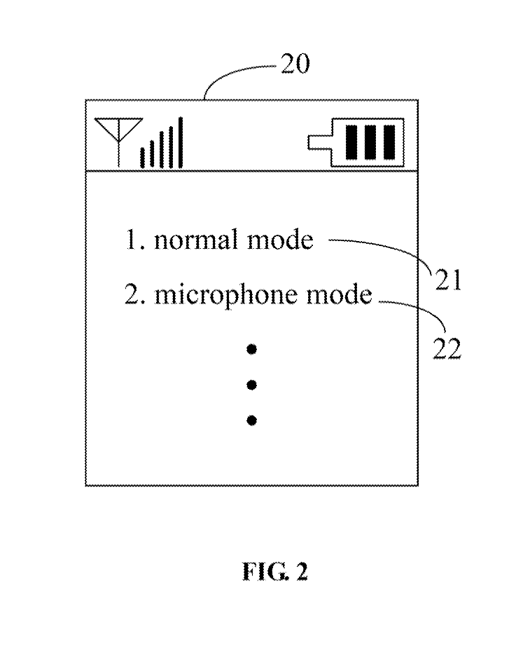

The mobile phone 1 has a plurality of operation modes. In each of the operation modes, the mobile phone 1 can perform a particular function. For simplicity, in this embodiment, the mobile phone 1 has two modes, e.g., a normal mode 21 and a microphone mode 22 (see FIG. 2). In the embodiment in FIG. 2, a graphical user interface (GUI) 20 of the mobile phone 1 illustrates two options, i.e., a normal mode 21 and a microphone mode 22. The options are selectable through the keypad 102 to control the mobile phone 1 to be in the normal mode or the microphone mode correspondingly. Thus, the mobile phone 1 enters or exits the microphone mode 22 according to operations on the keypad 102. The storage unit 101 is configured for storing application programs, for example, a program that configures a predefined key of the keypad 102. The predefined key may be an existing key or a newly added key on the keypad 102 and is used directly to control the mobile phone 1 to enter or exit the microphone mode 22.

In the normal mode 21, the processing unit 100 disables the switch unit 111, thus the mobile phone disconnects with the multimedia system 2. The first RF module 104 sends/receives wireless signals to/from the wireless communication system 3. That is, the mobile phone 1 can perform a real-time communication function with another mobile communication terminal via the receiver 106 and the microphone 105.

In the microphone mode 22, the processing unit 100 enables the switch unit 111, thus the second RF module 110 connects with the multimedia system 2. When the microphone 105 receives analog signals from a user, the ADC 108 converts the analog signals into digital signals, and the processing unit 100 processes and sends the digital signals to the converting unit 109. The DAC 107 converts the processed digital signals into analog signals, and the second RF module 110 transmits the wireless signals to the multimedia system 2. After receiving the wireless signals from the second RF module 110, the multimedia system 2 processes the signals and outputs audio signals. In another preferred embodiment, the switch unit 111 may be a toggle switch. When the switch unit 111 is actuated to control the mobile phone 1 to be in the normal mode 21, the second RF module 110 with the multimedia system 2 is disconnected. When the switch unit 111 is actuated to enable the microphone mode 22, the processing unit 100 turns on the switch unit 111, the second RF module 110 connects with the multimedia system 2 and the mobile phone 1 enters the microphone mode 22.

When the mobile phone 1 is in the microphone mode 22, the switch unit 111 is on, and the first RF module 104 still connects with the wireless communication system 3. Moreover, when the mobile phone 1 receives an incoming call signal from another mobile communication terminal, and if the incoming call is answered, the processing unit 100 immediately turns off the switch unit 111 and enters the normal mode 21, that is, the microphone mode 22 is disabled. The first RF module 104 receives wireless signals from the wireless communication system 3. The mobile phone 1 is configured for communicating with another mobile communication terminal via the wireless communication system 3. If the incoming call is not answered, the mobile phone 1 remains in the microphone mode, and the second RF module 110 continues to transmit wireless signals to the multimedia system 2.

In other embodiments, the mobile phone system does not include the switch unit 111, thus the processing unit 100 directly connects with the second RF module 110. Therefore, the processing unit 100 controls the second RF module 110 to transmit wireless signals to the multimedia system 2 or controls the first RF module 104 to transmit wireless signals to the wireless communication system 3 according to the operation modes. When entering the microphone mode operation on the keypad 102, the processing unit 100 controls and enables the second RF module 110 to transmit wireless signals to the multimedia system 2. When exiting the microphone mode operation on the keypad 102, the processing unit 100 controls and disabled the second RF module 110 to connect with the multimedia system 2.

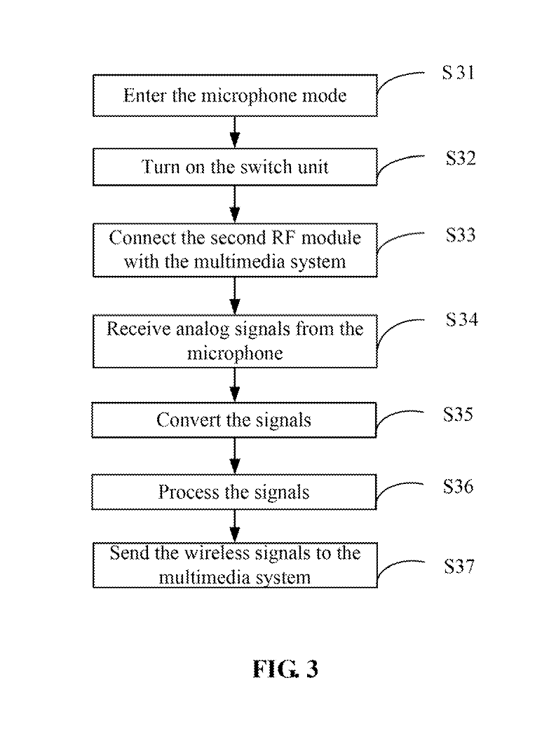

FIG. 3 is a flowchart of a preferred method for performing a wireless microphone function in the mobile phone of FIG. 1. The mobile phone 1 has two options, a normal mode and a microphone mode. In step S31, the mobile phone 1 enters the microphone mode 22 according to operations on the keypad 102. In step S32, the processing unit 100 sends a signal to turn on the switch unit 111. In step S33, the second RF module 110 connects with the multimedia system 2, that is, the second RF module 110 is able to transmit wireless signals to the multimedia system 2. In step S34, the converting unit 109 receives analog signals from the microphone 105. In step S35, the converting unit 109 converts the analog signals into digital signals. In step S36, the processing unit 100 processes and sends the digital signals to the converting unit 109. In step S37, the DAC 107 converts the digital signals into analog signals, and the second RF module 110 sends the wireless signals to the multimedia system 2.

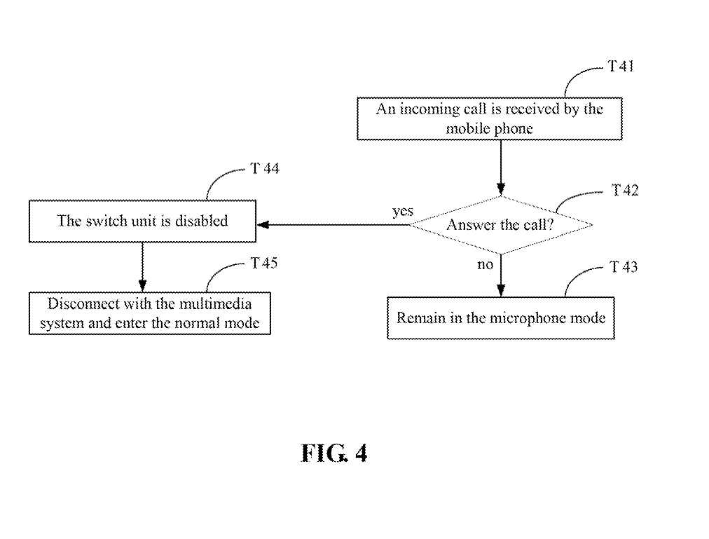

FIG. 4 is a flowchart of a preferred method for performing an incoming call of the mobile phone of FIG. 1 in the microphone mode. In step T41, if an incoming call is received by the mobile phone 1 from the wireless communication system 3 while in the microphone mode 22, the first RF module 104 of the mobile phone 1 establishes communication with the communication system 3. In step T42, the processing unit 100 determines whether the user accepts the call by receiving a signal indicative of answering the incoming call. In step T43, if the incoming call is not answered, the second RF module 110 continues transmitting wireless signals to the multimedia system 2, and the mobile phone 1 remains in the microphone mode 22. In step T44, if the incoming call is answered, the processing unit 100 immediately sends a signal to turn off the switch unit 111. In step T45, the second RF module 110 disconnects with the multimedia system 2, that is, the second RF module 110 stops transmitting wireless signals to the multimedia system 2, and the mobile phone 1 enters the normal mode 21, thereby the mobile phone 1 can connect with another mobile communication terminal via the wireless communication system 3.

Although the present invention has been explained in relation to its preferred embodiment and preferred methods, it is to be understood that many other possible modifications and variations can be made without departing from the spirit and scope of the invention as hereinafter claimed.

What is claimed is:

1. A mobile phone to be used as a wireless microphone, comprising:
an input unit for generating input operations;
a first RF module for sending/receiving wireless signals to/from a wireless communication system;
a converting unit for converting the received signals;
a second RF module connecting with the converting unit, for transmitting wireless signals to a multimedia system;
a switch unit connected to the second RF module; and
a processing unit for controlling the mobile phone according to operations on the input unit;
wherein the mobile phone has a normal mode and a microphone mode, when the mobile phone is in the normal mode, the processing unit controls the switch unit being off and the first RF module transmits signals from the converting unit; and
when the mobile phone is in the microphone mode, the processing unit controls the switch unit being on and the second RF module transmits signals from the converting unit.

2. The mobile phone as recited in claim 1, further comprising a display unit, wherein the display unit provides a graphical user interface (GUI), which displays the microphone mode and the normal mode for selection.

3. The mobile phone as recited in claim 1, wherein the input unit comprises a key for selecting the microphone mode.

4. The mobile phone as recited in claim 1, further comprising a microphone for receiving analog signals from a user to the converting unit.

5. The mobile phone as recited in claim 1, wherein the switch unit is a toggle switch.

6. The mobile phone as recited in claim 1, wherein when the mobile phone exits the microphone mode, the processing unit turns off the switch unit.

7. The mobile phone as recited in claim 1, wherein when the mobile phone is in the microphone mode and the first RF module receives an incoming call signal from a wireless communication system, and if the incoming call is answered, the processing unit turns off the switch unit.

8. The mobile phone as recited in claim 7, wherein if the incoming call is not answered, the mobile phone remains in the microphone mode.

9. The mobile phone as recited in claim 1, wherein when the switch unit is disabled, the second RF module disconnects with the multimedia system.

10. The mobile phone as recited in claim 1, wherein the converting unit comprises a DAC and an ADC, the DAC is a digital to analog converter, and the ADC is an analog to digital converter.

11. The mobile phone as recited in claim 1, wherein the second RF module is a Bluetooth module.

12. A mobile phone to be used as a wireless microphone, comprising:
an input unit for generating input operations;
a first RF module for sending/receiving wireless signals to/from a wireless communication system;
a converting unit for converting the received signals;
a processing unit for controlling the mobile phone according to operations on the input unit; and
a second RF module connecting with the converting unit, for transmitting wireless signals to a multimedia system;
wherein the mobile phone has a microphone mode option, when the mobile phone is in the microphone mode, the processing unit controls the second RF module to transmit wireless signals from the converting unit to the multimedia system.

13. The mobile phone as recited in claim 12, wherein when the mobile phone is in the microphone mode and the first RF module receives an incoming call signal from the wireless communication system, and if the incoming call is answered, the second RF module disconnects with the multimedia system.

14. The mobile phone as recited in claim 12, wherein if the incoming call is not answered, the mobile phone remains in the microphone mode.

15. The mobile phone as recited in claim 12, further comprising a switch unit, wherein when the switch unit is enabled, the second RF module transmits wireless signals to the multimedia system; when the switch unit is disabled, the second RF module disconnects with the multimedia system.

16. The mobile phone as recited in claim 12, further comprising a display unit, wherein the display unit provides a graphical user interface (GUI), which displays the microphone mode for selection.
